(19) United States
(12) Patent Application Publication
(10) Pub. No.: US 2024/0037591 A1
(43) Pub. Date: Feb. 1, 2024

(54) TECHNIQUES FOR REDEMPTION VIA WEBPAGE UNIQUE ASSET TOKENS

(71) Applicant: Concept Source, Inc., Plainview, NY (US)

(72) Inventors: Charles RAFFAY, Jensen Beach, FL (US); Robert FALLAS, Huntington, NY (US)

(73) Assignee: CONCEPT SOURCE, INC., PLAINVIEW, NY (US)

(21) Appl. No.: 18/484,799

(22) Filed: Oct. 11, 2023

Related U.S. Application Data
(63) Continuation-in-part of application No. 17/651,125, filed on Feb. 15, 2022, now Pat. No. 11,822,944.
(60) Provisional application No. 63/380,292, filed on Oct. 20, 2022.

(51) Int. Cl. G06Q 30/0207; H04L 9/40

(52) U.S. Cl. CPC G06Q 30/0209; H04L 63/08; H04L 2463/082; G06Q 2220/00

(57) ABSTRACT

Techniques for providing redemptions via webpage unique asset tokens (UATs). A method incudes obtaining authenticity data from a user device when the user device has navigated to a webpage uniquely associated with a unique asset token (UAT), wherein the webpage is encoded into portions of code including code for providing the authenticity data; accessing a database with respect to the authenticity data in order to retrieve a redemption status of a premium, the database storing UAT nodes and premium nodes, wherein a first UAT node corresponds to the UAT and is connected to a first premium node, the first premium node representing the premium to be redeemed, wherein the portions of the code of the webpage are stored among the nodes; verifying eligibility of the premium based on the redemption status of the first premium node; and redeeming the premium when the eligibility of the premium has been verified.

### CROSS-REFERENCE TO RELATED APPLICATIONS

This application claims the benefit of U.S. Provisional Patent Application No. 63/380,292 filed on Oct. 20, 2022. This application is also a continuation-in-part of U.S. patent application Ser. No. 17/651,125 filed on Feb. 15, 2022, now allowed.

The contents of the above-referenced applications are hereby incorporated by reference.

### TECHNICAL FIELD

The present disclosure relates generally to webpages as unique asset tokens (UATs) such as non-fungible tokens (NFTs), and more specifically to providing redemptions via webpage UATs.

### BACKGROUND

A non-fungible token (NFT) is a non-interchangeable unit of data associated with an asset such as a physical or digital item. Because NFTs are unique, they can be utilized to provide data scarcity even for data that is easily replicated. Thus, owning an NFT can provide the ability to own data uniquely (i.e., such that only a single person or entity owns that data) or semi-uniquely (such as when a limited group of people each own a copy of the data). NFTs typically cannot be copied or transferred without permission, and can serve as a proof of authenticity as well as a means for accessing the owned assets.

Existing solutions for providing NFTs record transactions involving transfers of NFTs to a blockchain. A blockchain is a distributed digital ledger storing transaction data, where the distributed ledger is stored on multiple nodes such that each node is a computer storing a copy of the blockchain. Because copies of the blockchain are stored across multiple nodes, records cannot be altered on one node in order to falsify the records among the nodes. When new transaction data is to be added to the blockchain, the nodes validate the new transaction data and reach consensus regarding what data should be included in the updated blockchain. When such consensus occurs, transaction data is recorded on the blockchain on each node.

Although data stored on the blockchain can be retrieved in order to demonstrate the history of transactions involving an NFT, this information is often inadequate. In particular, due to the anonymous nature of many blockchain transactions, the true source of any given NFT may be obscured in the blockchain records. This effectively allows any entity, regardless of whether they are the originator of the underlying assets represented, to mint and sell NFTs of those assets, thereby permitting counterfeiting of NFTs for those assets. Moreover, due to the irreversible nature of transactions on blockchains, it can be difficult or impossible to undo such counterfeit NFTs. As a result, opportunities for misusing existing blockchain and NFT solutions present a significant challenge.

These counterfeiting problems may further pose challenges in adopting NFTs for purposes other than simply owning digital assets. In particular, in order to implement NFTs to allow users to redeem rewards, it is critical to verify the authenticity of the NFT. Moreover, to be practical for such uses, techniques for quickly yet accurately verifying the authenticity of NFTs used in order to facilitate redemptions are needed.

Given the above challenges and many more, new solutions for demonstrating authenticity of NFTs and for using such proofs of authenticity to provide redemptions are desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for providing redemptions via webpage unique asset tokens (UATs). The method comprises: obtaining authenticity data from a user device when the user device has navigated to a webpage uniquely associated with a unique asset token (UAT), wherein the webpage is encoded into a plurality of portions of code including code for providing the authenticity data; accessing a database with respect to the authenticity data in order to retrieve at least a redemption status of a premium to be redeemed, the database storing a plurality of nodes including a plurality of UAT nodes and a plurality of premium nodes, wherein a first UAT node of the plurality of UAT nodes corresponds to the UAT and is connected to a first premium node of the plurality of premium nodes, the first premium node representing the premium to be redeemed, wherein the plurality of portions of the code of the webpage is stored among the plurality of nodes; verifying eligibility of the premium for redemption based on the redemption status of the first premium node; and redeeming the premium when the eligibility of the premium has been verified.

Certain embodiments disclosed herein also include a non-transitory computer readable medium having stored thereon causing a processing circuitry to execute a process, the process comprising: obtaining authenticity data from a user device when the user device has navigated to a webpage uniquely associated with a unique asset token (UAT), wherein the webpage is encoded into a plurality of portions of code including code for providing the authenticity data; accessing a database with respect to the authenticity data in order to retrieve at least a redemption status of a premium to be redeemed, the database storing a plurality of nodes including a plurality of UAT nodes and a plurality of premium nodes, wherein a first UAT node of the plurality of UAT nodes corresponds to the UAT and is connected to a first premium node of the plurality of premium nodes, the first premium node representing the premium to be redeemed, wherein the plurality of portions of the code of the webpage is stored among the plurality of nodes; verifying eligibility of the premium for redemption based on the redemption status of the first premium node; and redeeming the premium when the eligibility of the premium has been verified.

Certain embodiments disclosed herein also include a system for providing redemptions via webpage unique asset tokens (UATs). The system comprises: a processing circuitry; and a memory, the memory containing instructions that, when executed by the processing circuitry, configure the system to: obtain authenticity data from a user device when the user device has navigated to a webpage uniquely associated with a unique asset token (UAT), wherein the webpage is encoded into a plurality of portions of code including code for providing the authenticity data; access a database with respect to the authenticity data in order to retrieve at least a redemption status of a premium to be redeemed, the database storing a plurality of nodes including a plurality of UAT nodes and a plurality of premium nodes, wherein a first UAT node of the plurality of UAT nodes corresponds to the UAT and is connected to a first premium node of the plurality of premium nodes, the first premium node representing the premium to be redeemed, wherein the plurality of portions of the code of the webpage is stored among the plurality of nodes; verify eligibility of the premium for redemption based on the redemption status of the first premium node; and redeem the premium when the eligibility of the premium has been verified.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2A is a visual depiction of nodes in a database realized as a hypergraph.

FIG. 2B is a visual depiction of nodes in a database including a voting node.

FIG. 2C is a visual depiction of nodes in a database including a token series node.

FIG. 3 is a flow diagram illustrating interactions between a user device, a redemption provider device, and a database storing code of webpage unique asset tokens (UATs).

FIG. 4 is a flowchart illustrating a method for providing a redemption via a webpage UAT according to an embodiment.

FIG. 5 is a flowchart illustrating a method for demonstrating authenticity via an authenticity graphical user interface in order to enact a redemption.

FIG. 6 is a flowchart illustrating a method for delivering authenticity graphical user interface display areas via webpage UATs according to an embodiment.

FIG. 7 is a flowchart illustrating a method for creating a UAT database according to an embodiment.

FIG. 8 is a schematic diagram of a UAT provider system according to an embodiment.

FIG. 9 is a schematic diagram of a redemption provider device according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include techniques for providing redemptions via webpage unique asset tokens (UATs), thereby allowing for establishing authenticity of those UATs. In accordance with various disclosed embodiments, eligibility for a redemption via a user device is verified based on authenticity data associated with a UAT encoded as a webpage and accessed by the user device. The encoded webpage includes code for projecting media content representing a unique digital or physical asset, and may further include code for displaying a graphical user interface (GUI) display area including at least a portion of authenticity data associated with the UAT.

Code of the webpage is distributed among a database, and a node representing the UAT is linked to both a node representing a respective authenticity token as well as one or more nodes representing respective redeemable premiums. The webpage UAT is uniquely assigned to a user such that the ability to access the webpage UAT, for example by navigating to a uniform resource locator (URL) of the corresponding webpage UAT, demonstrates proof of ownership of the webpage UAT. In accordance with various disclosed embodiments, the node representing the UAT may further be connected to a node representing the premium which includes data indicating a redemption status of the premium.

Authenticity data of the webpage UAT may be retrieved by accessing the webpage UAT via the user device, and the authenticity data may be utilized in order to verify the authenticity of the webpage UAT before a premium is redeemed. The authenticity data of the webpage UAT may be used to identify the webpage UAT in the database (e.g., by identifying the UAT node representing the webpage UAT), and the database is accessed with respect to the identified webpage UAT in order to retrieve data including a redemption status of the premium.

Based on the retrieved redemption status, an eligibility to redeem the premium is confirmed, and the premium is redeemed. The premium redemption may include, for example but not limited to, providing media content to the user device, sending a notification to provide the premium to the user of the user device, and the like.

In accordance with various disclosed embodiments, the web content provided when the user navigates to the webpage associated with the UAT node may include interactable icons or other user interface elements. In some embodiments, the portions of the code for the webpage include code for rendering a GUI display area populated with authenticity data for the UAT that is retrieved from the database when a user interacts with the interactable elements. Such authenticity data may include, but is not limited to, an originator of the UAT, marketplace(s) on which the UAT is listed, transaction history of the UAT, combinations thereof, and the like. The GUI display area populated with the authenticity data may be, but is not limited to, a window or portion thereof.

In some embodiments, the GUI display area may include a machine-readable optical label such as a QR code or other barcode. The machine-readable optical label includes information which can be used to verify the authenticity of the UAT, where this information may be displayed on a device of the verifying entity when the device scans the machine-readable optical label (e.g., via a camera of the device). To this end, the information may include, but is not limited to, the authenticity data, the web content of the webpage corresponding to the UAT, a link to an external authenticity webpage, a link to one or more marketplaces on which the UAT is listed, a combination thereof, and the like. This, in turn, may allow the redemption provider device to access authenticity data of the webpage UAT in order to allow for verifying the authenticity of the webpage UAT, identifying the webpage UAT in a database to enable identifying data of the premium including the premium's redemption status, or both.

Other disclosed embodiments enable providing the authenticity data of the webpage UAT via alternative channels such as, but not limited to, near field communication (NFC) between a user device and a redemption provider device. Such NFC may include wirelessly communicating between devices that are physically proximate (e.g., within a threshold distance). Such a physical proximity may be, but is not limited to, the devices being within 2 inches of each other. Yet other embodiments may include providing the authenticity data of the webpage UAT from a user device to a redemption provider device via a wired connection.

In this regard, authenticity data provided in accordance with various disclosed embodiments can serve as a certificate of authenticity for the corresponding UAT. More specifically, showing the GUI display area including the relevant authenticity information or initiating a near field communication in order to transmit authenticity data may demonstrate the authenticity of the underlying webpage UAT to a person or system viewing the GUI display area, which in turn may be utilized to allow for verifying a user's eligibility to redeem a premium based on their ownership of the webpage UAT associated with the premium and a redemption status of the premium.

Additionally, because the webpage UAT described herein is uniquely associated with a user, accessing the webpage of the webpage UAT may serve as a factor of authentication demonstrating the user's identity. Moreover, because the webpage UAT is encoded into portions of code including code for displaying or transmitting authenticity data, the webpage UAT may provide information which can be used to verify its own authenticity in order to defeat attempts at counterfeiting the UAT. The result of these features is that a redemption verified based on ownership of the UAT can be performed securely and in a manner which ensures that only the proper owner of the UAT can redeem the premium.

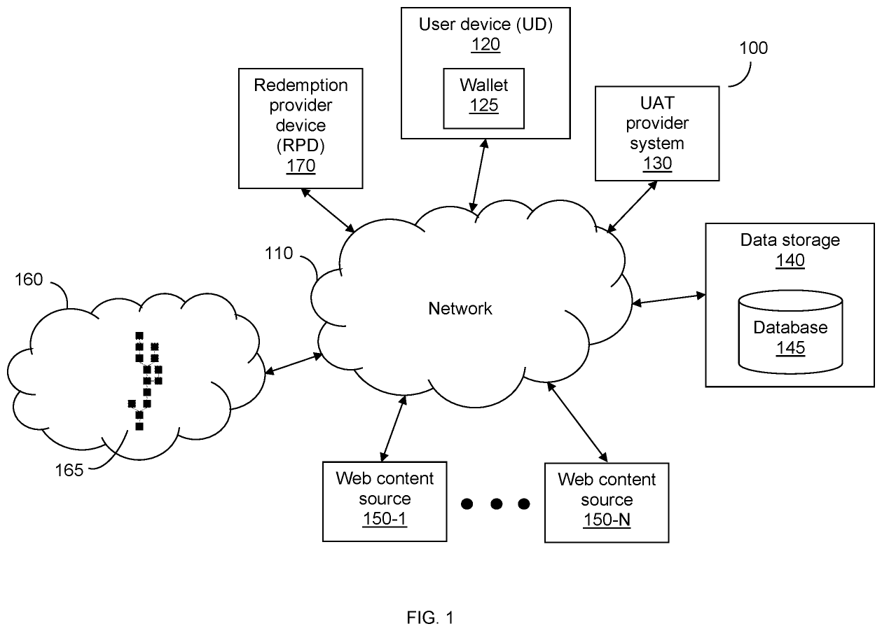

FIG. 1 shows an example network diagram 100 utilized to describe the various disclosed embodiments. In the example network diagram 100, a user device 120, a unique asset token (UAT) provider system 130, a data storage 140, a plurality of web content sources 150-1 through 150-N (hereinafter referred to individually as an web content source 150 and collectively as web content sources 150, merely for simplicity purposes), a blockchain network 160, and a redemption provider device 170 communicate via a network 110.

The network 110 may be, but is not limited to, a wireless, cellular or wired network, a local area network (LAN), a wide area network (WAN), a metro area network (MAN), the Internet, the worldwide web (WWW), similar networks, and any combinations thereof.

The user device (UD) 120 may be, but is not limited to, a personal computer, a laptop, a tablet computer, a smartphone, a wearable computing device, or any other device capable of receiving and executing code in order to configure the user device to display webpages or portions thereof via a graphical user interface (not shown). The user device is equipped with one or more input/output (I/O) devices (not depicted in FIG. 1) which can display or otherwise project webpage content. To this end, the user device 120 may have installed thereon a web browser (not shown) or other software for viewing or otherwise navigating to webpages.

As depicted in FIG. 1, the user device 120 includes a wallet 125. In this implementation, the wallet 125 may be a program stored and executed on the user device 120. In other implementations, the wallet 125 may be a device (not depicted in FIG. 1) connected to the user device 120. In yet other implementations, the wallet 125 may be stored on another system (not depicted in FIG. 1) such as a server of a UAT platform or another server owned by a provider of UAT services. The wallet 125 stores ownership data used to access the media content of webpages represented in the database 145 such as, but not limited to, token ownership data, authentication credentials, and the like.

The UAT provider system 130 is configured to at least encode webpages and create databases (e.g., a database 145) including nodes and webpage code as described herein. The UAT provider system 130 may be further configured to provide media content associated with webpages to owners of UAT nodes in the database 145 as described herein.

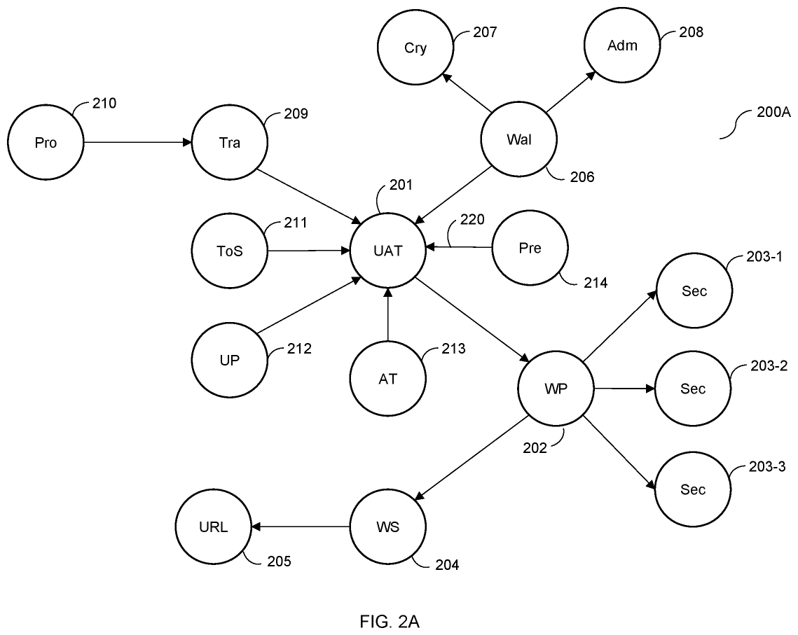

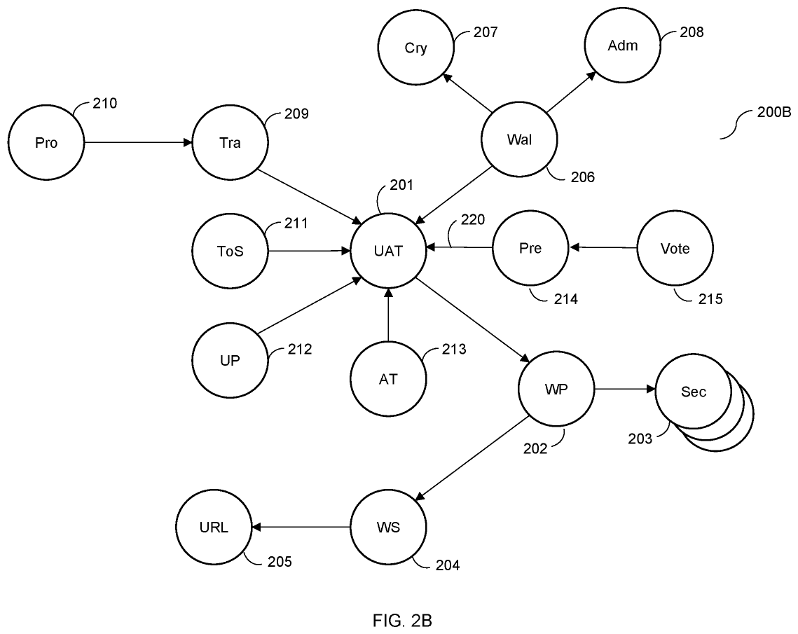

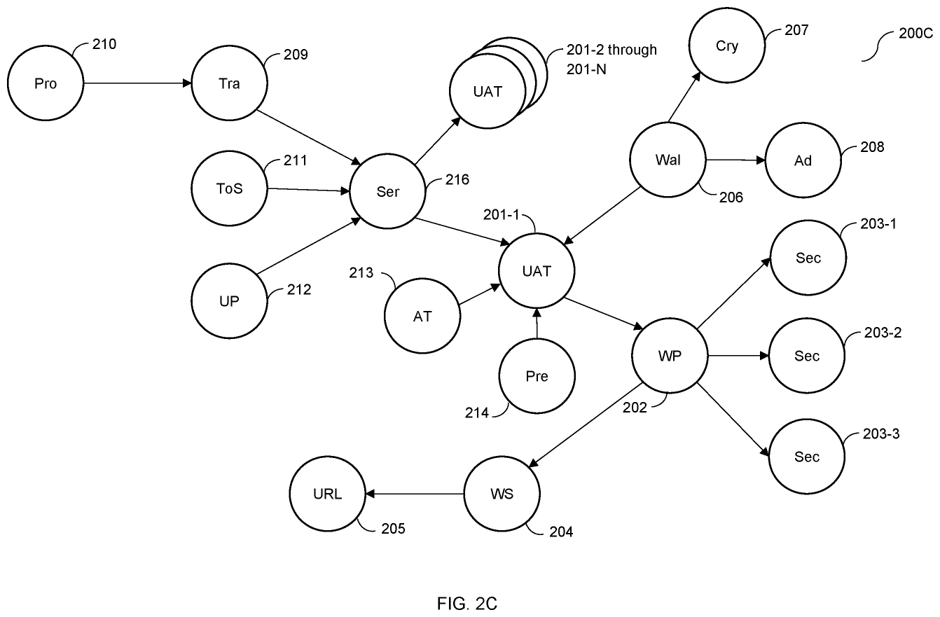

The data storage 140 stores a database 145 that is at least partially populated with code and nodes created by the UAT provider system 130 as described herein. The database 145 stores nodes (not depicted in FIG. 1) connected to each other (e.g., via edges). The nodes at least include webpage nodes associated with respective webpages, UAT nodes associated with UAT defined with respect to content of the webpages, and premium nodes representing redeemable premiums associated with respective UAT. The webpages in the graphs include portions of code for displaying content of the webpages (e.g., media content of the UAT or otherwise representing the UAT). In an embodiment, the database 145 may be realized as a graph (e.g., a hypergraph such as a multi-tenant temporal hypergraph). An example illustration of nodes in the database 145 realized as a graph is described further below with respect to FIG. 2.

The web content sources 150 store content of webpages including, but not limited to, media content. Such content is encoded by the UAT provider system 130 as described herein and stored in the database 145 in order to enable providing the appropriate content when an owner of a UAT (e.g., a user of the user device 120) requests to access the content associated with the UATs they own.

The blockchain network 160 includes multiple computing nodes (not shown), each computing node storing a copy of a blockchain 165. In various embodiments, the database 145 or a copy of the database 145 may be stored on the blockchain 165, thereby enabling the benefits of such blockchain use discussed above. To this end, in some embodiments, the UAT provider system 130 may be configured to upload transactions to the blockchain 165 as the database 145 is updated. The transactions uploaded to the blockchain 165 may include a full copy of the database 145 or one or more changes to the existing copy of the database 145.

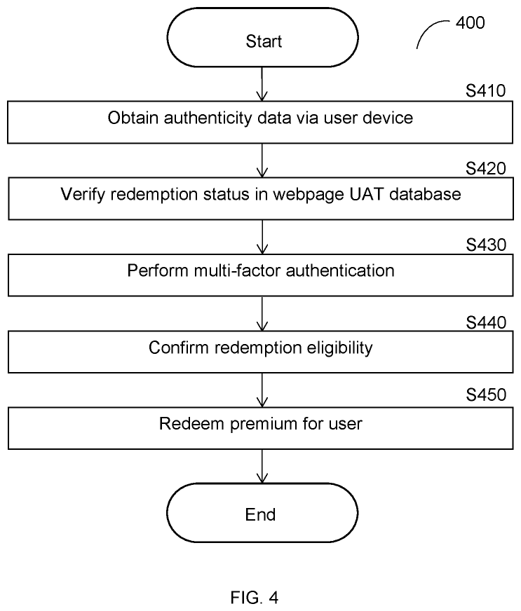

The redemption provider device (RPD) 170 is configured to verify eligibility for redemptions and to redeem premiums based on data stored in nodes of the database 145. More specifically, an authenticity GUI display area may be displayed on a display of the user device 120, and the redemption provider device 170 is configured to scan the authenticity GUI display area on the user device 120 (e.g., scanning a machine-readable optical label displayed on a screen of the user device 120) and to access the database 145 with respect to the scanned authenticity GUI display area (e.g., by accessing the premium node connected to the same UAT node as the authenticity token node representing the authenticity token displayed in the authenticity GUI display area). An example method illustrating operation of the redemption provider device 170 is described further below with respect to FIG. 4.

It should be noted that the network diagram 100 is merely an example, and that other combinations of networked components may be equally utilized without departing from the scope of the disclosure. Further, it should be noted that all components illustrated in FIG. 1 are depicted as communicating via a single network 110 merely for simplicity, but that different networks or no networks may be used for different communications among the components without departing from the scope of the disclosure.

FIG. 2A is a non-limiting example visual depiction 200A of nodes in a database realized as a hypergraph.

The example visual depiction 200A includes various nodes connected to a UAT node 201. The UAT node 201 represents a tokenized version of a unique digital asset (not shown) such as, but not limited to, an NFT or PDT. The unique asset is represented by media content included in a webpage such that the webpage can be encoded into portions of code (e.g., code in hypertext markup language) for projecting the media content representing the UAT.

In accordance with various disclosed embodiments, the UAT node 201 further includes transaction data indicating historical transactions involving the UAT represented by the UAT node 201 (e.g., transactions which resulted in modification of the database involving changing connections between the UAT node 201 and wallet nodes or owning entity nodes), the initial creation of the UAT node 201, both, and the like. Consequently, the UAT node 201 may also include a complete history of ownership of the UAT. Storing such historical data allows the UAT node 201 to serve as a proof of authenticity or otherwise as a proof of ownership history for the UAT represented by the UAT node 201.

Alternatively, such historical data and any other data related to authenticity may be stored in an authenticity token (AT) node 213 connected to the UAT node 201. The authenticity token node 213 may include, but is not limited to, historical transactions involving the UAT represented by the UAT node 201, an originator of the UAT represented by the UAT node 201 (e.g., a platform or entity which issued or otherwise minted the UAT), both, and the like. In some implementations, the authenticity token node 213 may be accessed when authenticity data is needed to populate an authenticity webpage or authenticity display area. To this end, the portions of code for the webpage may include code that causes retrieval of the authenticity data from the authenticity token node when executed.

Additionally, in accordance with various disclosed embodiments, the UAT node 201 is connected to a premium node 214 representing a premium which can be redeemed that is associated with the UAT represented by the UAT node 201. To this end, the premium node 214 at least includes a redemption status of the premium (e.g., whether the premium has been redeemed or not), and may also include, but is not limited to, data related to the redeemable premium, a number of times the premium is allowed to be redeemed, a number of times the premium has been redeemed, a combination thereof, and the like. It should be noted that a single premium node is depicted in FIGS. 2A-B merely as an example, and that multiple premium nodes may be connected to a given UAT node without departing from the scope of the disclosure.

The premium node 214 may be accessed (e.g., by the redemption provider device 170, FIG. 1) in order to verify the redemption status (i.e., to verify that the premium represented by the premium node 214 has not been redeemed or otherwise is still eligible for redemption such as by verifying that the number of times the premium has been redeemed is less than the number of times the premium is allowed to be redeemed). Accessing the premium node 214 to verify a redemption status is described further herein below with respect to FIG. 4.

In some embodiments, the premium node 214 is connected to the UAT node 201 via an edge 220. In a further embodiment, the edge 220 is also a node, referred to as a premium-to-UAT node. An auxiliary table (not shown) may be stored in the premium-to-UAT node (i.e., in the edge 220). The auxiliary table may include, but is not limited to, the redemption status of the premium 214, a redemption history record of the premium 214 indicating each time the premium 214 was redeemed, both, and the like. It should be noted that the premium-to-UAT node is depicted as an edge 220 between the premium node 214 and the UAT node 201 for example purposes, but that the premium-to-UAT node may be realized as a non-edge node without departing from the scope of the disclosure. As a non-limiting example, the premium-to-UAT node may be realized as a node connected to the UAT node 201 via a first edge (not shown) and to the premium node 214 via a second edge (not shown).

In some embodiments, the premium may be associated with a vote such that successfully redeeming the premium via a user device allows the user of the user device to cast a vote. In such an embodiment, the database may further include a voting node. FIG. 2B is a non-limiting example visual depiction 200B illustrating such an embodiment. As shown in FIG. 2B, the premium node 214 is further connected to a voting (vote) node 215. The voting node 215 may include, but is not limited to, data indicating a voting record associated with the redeemed premium represented by the connected premium node 214. Such a voting record may indicate each choice made by the user during the vote (e.g., the choice for each of one or more questions). When various premium nodes (not shown) connected to respective voting nodes (not shown) are in the database, the database may serve as a voting records database which can be accessed in order to check the result of a vote or to verify the authenticity of votes which were cast.

As noted herein, because the webpage UAT according to various disclosed embodiments is uniquely associated with and accessible to a given user, casting a vote via premium redemption by accessing the webpage UAT as described herein allows for authenticating the user, thereby verifying the user's identity in order to secure voting. Further, by realizing the vote via premiums that can only be redeemed once, the disclosed embodiments also allow for ensuring that each user is only able to successfully cast a vote once. Likewise, when the voting is performed as a means of taking a survey (i.e., by realizing survey responses as votes), the disclosed embodiments allow for ensuring that the same person is not surveyed twice by linking survey responses as voting nodes to UAT nodes that are uniquely associated with respective users.

Returning to FIG. 2A, the UAT node 201 is connected to a webpage (WP) node 202 representing a corresponding webpage tokenized via the hypergraph. In various embodiments, the UAT node 201 includes one or more portions of code created by encoding the corresponding webpage represented by the webpage node 202 connected to the UAT node 201. Such portions of code may include instructions in formats such as, but not limited to, cascading style sheets (CSS), Javascript, hypertext markup language (HTML), combinations thereof, and the like. In other embodiments (not shown), such portions of code may be stored in code nodes (not shown) which are distinct from the UAT node 201 and are connected to the UAT node 201, the webpage node 202, or both. Such portions of code can be provided to an authorized device, thereby allowing such an authorized device to use the portions of code to generate a view of the webpage including any applicable media content.

In some embodiments, the webpage node 202 may further be connected to multiple section nodes such as section (Sec) nodes 203-1 through 203-3. The section nodes 203-1 through 203-3 represent different sections of the webpage represented by the connected webpage node 202. By representing sections of webpages as distinct nodes, webpage tokenization may be realized in a more granular fashion, i.e., such that multiple tokens may be created for a single webpage and multiple owning entities may each effectively own a different portion of the same webpage. The portion of a webpage for a respective owning entity may be represented and rendered as a distinct webpage including the corresponding content owned by that entity.

The webpage node 202 may further be connected to a website (WS) node 204 representing the website including the webpage represented by the webpage node 202. The website node 204 may further be connected to other webpage nodes (not shown) representing various webpages of the website. Additionally, the website node 204 may be connected to a location node such as a uniform resource locator (URL) node 205 representing a URL associated with the webpage. In other embodiments (not shown), each webpage node may also be connected to a corresponding URL node indicating the location of the respective webpage on the Internet.

The UAT node 201 may further be connected to a node associated with an entity that owns the UAT of the UAT node 201 such as the wallet (Wal) node 206. The wallet node 206 represents and stores data indicating ownership of the UAT represented by the UAT node 201 such that the connection between the wallet node 206 and the UAT node 201 can be utilized to confirm ownership of the UAT by the owner of the wallet. The wallet node 206 may also optionally represent a wallet (e.g., the wallet 125, FIG. 1).

The wallet node 206, in turn, may be connected to one or more cryptocurrency (Cry) nodes 207, a wallet administrator (Adm) node 208, or both. The cryptocurrency nodes 207 may represent cryptocurrency owned by the owner of the wallet. Such cryptocurrency may be used to conduct transactions involving transfers of UATs such as using the cryptocurrency to purchase a UAT to be transferred to the wallet or receiving cryptocurrency as payment for such a UAT. The wallet administrator node 208 may be associated with an administrator of the wallet (e.g., the owner of the wallet or a third party entity who has been granted the right to act on behalf of the wallet owner), and may store data indicating policies related to use of the wallet.

In some implementations (not shown), multiple wallet administrator nodes may be connected to any given wallet node, and each administrator represented by one of the wallet administrator nodes may own a fractional share of the wallet. Each wallet administrator node may further include data indicating a percentage of ownership of the wallet by the administrator associated with the wallet administrator node. This percentage of ownership may further be connected to an accounting system (not shown), which may represent balances in any currency.

The UAT node 201 may further be connected to one or more nodes representing policies to be applied in relation to creation, use, or access of UAT nodes such as, but not limited to, a transfer node 209, a terms of service (ToS) node 211, a usage policy (UP) node 212, or a combination thereof.

The transfer node 209 may act as a minting contract, i.e., a smart contract defining policies for creation of UAT nodes for webpages (i.e., minting of webpages as UATs). To this end, the transfer node 209 may store code that, when executed, applies the rules of the policy to the creation of UAT nodes such as the UAT node 201. Such policies may include, but are not limited to, restrictions on the number of UATs which can be created (i.e., the number of UAT nodes which can be created) for a given webpage or portion thereof. As a non-limiting example, such a policy may limit the creation of UATs for a given webpage to 100 UATs total.

In some implementations, the transfer node 209 may further be connected to a provider (Pro) node 210 representing a provider of the UAT. Such a provider may be, but is not limited to, a creator of the UAT, a company representing the creator of the UAT, and the like. In this regard, the provider node 210 may serve as evidence of the originator of the UAT node 201.

The terms of service node 211 includes code that, when executed, applies the rules of one or more policies defining terms of service for a UAT. Such policies may require, for example, that a user to whom the UAT is transferred (e.g., a user of a wallet represented by a wallet node to which the UAT node will be connected) agree to terms of service before being granted ownership of or access to the UAT.

The usage policy node 212 includes code that, when executed, applies the rules of one or more policies defining restrictions on use of a UAT, access to the UAT, both, and the like. Such restrictions may include, but are not limited to, requiring that UATs not be shared for free, limiting the number of uses of a given UAT, and the like. In various embodiments, multiple usage policies (which may be represented by multiple usage policy nodes, not shown), may be applied to any given UAT or series of UATs. The usage policies may be defined by a platform for the UATs, a marketplace for the UATs, a provider of a UAT, or a combination thereof, depending on the implementation.

In a further embodiment, the usage policy represented by the usage policy node 212 may require an access code before using or accessing the UAT of the connected UAT node 201 in order to prevent unauthorized access. To this end, the UAT node 201 may also be connected to an access code node (not shown) representing an access code required to use or access the UAT. As a non-limiting example, before web content of the webpage represented by the webpage node 202 is provided, a user of the wallet represented by the wallet node 206 or other user indicated by the wallet node 206 may be required to enter the access code indicated by the access code node.

FIG. 2C is a non-limiting example visual depiction 200B of nodes in a database including a token series node. As depicted in FIG. 2C, the nodes of the database further include a UAT series (Ser) node 216. The UAT series node 216 may define a series of related UATs such as, but not limited to, music tracks of an album, art pieces in a collection, and the like.

The UAT series node 216 is connected to multiple UAT nodes including the UAT node 201-1 and other UAT nodes 201-2 through 201-N. As depicted in FIG. 2C, the series node 216 may be connected to any of the transfer node 209, the terms of service node 211, and the usage policy node 212, such that rules and policies defined in data of those nodes may be applied to all of the UATs represented by the UAT nodes 201-1 through 201-N. Accordingly, using series nodes such as the UAT series node 216 allows for defining policies for groupings of UATs rather than defining policies individually per UAT. As new UATs are added to a series (for example, by connecting new UAT nodes to the UAT series node 216), the policies for the UAT series node 216 may be automatically linked to their respective UAT nodes via the connections in the database.

Further, in another implementation (not depicted in FIG. 2C), additional policy-related nodes (e.g., additional transfer nodes, terms of service nodes, and/or usage policy nodes) may be connected to any or all of the UAT nodes 201-1 through 201-N such that, in addition to any policies applicable to all UATs in the series, each UAT may have its own policies applied.

It should be noted that FIGS. 2A-C depict various specific numbers of nodes, numbers of connections, types of nodes, and connections between different types of nodes for example purposes, but that the disclosed embodiments are not necessarily limited to the specific depiction of nodes and connections illustrated in FIG. 2. In particular, only one instance of many types of nodes are depicted in FIGS. 2A-C or simplicity purposes, but in various implementations multiple of each node may be included without departing from the scope of the disclosure. Further, the additional UAT nodes 201-2 through 201-N are depicted without connections to nodes other than the series node 216 merely for simplicity, and that, in various implementations, each of these UATs 201-2 through 201-N may be connected to other nodes.

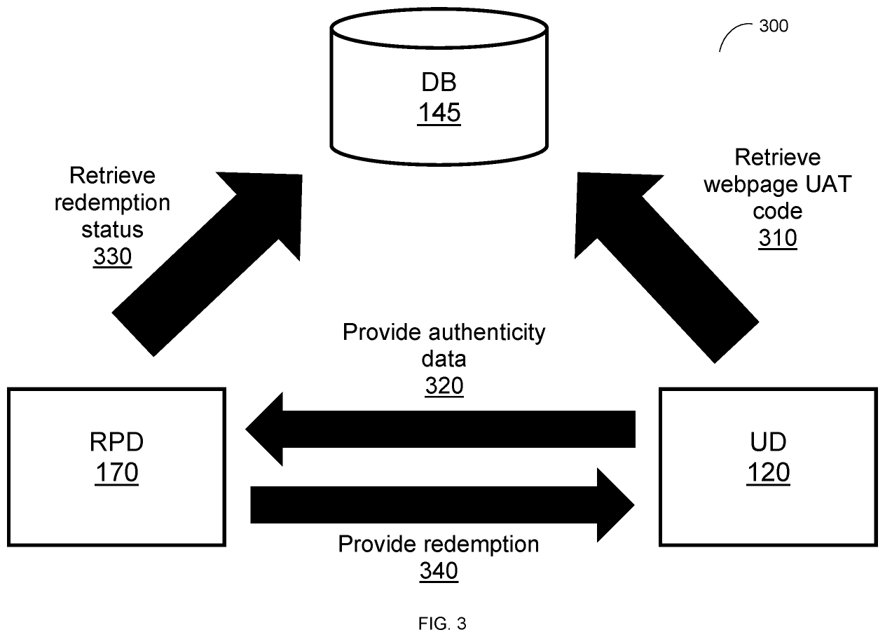

FIG. 3 is a flow diagram 300 illustrating interactions between a user device, a redemption provider device, and a database storing code of webpage unique asset tokens.

As depicted in FIG. 3, the user device (UD) 120 and the redemption provider device (RPD) 170 communicate with each other and with the database (DB) 145. The process depicted in FIG. 3 begins at 310 with the user device 120 retrieving code of a webpage UAT from the database 145. This retrieval may occur when, as a non-limiting example, a user of the user device 120 inputs a uniform resource locator (URL) of the webpage UAT represented in the database or otherwise navigates to that webpage UAT via a web browser (not shown) installed on the user device 120.

The retrieved code is executed on the user device 120, thereby causing at least a portion of media content of the webpage UAT to be displayed on the user device 120. At S320, the user interacts with the webpage UAT in order to trigger providing the authenticity token graphical user interface (GUI) to the redemption provider device 170 as described herein.

As a non-limiting example for providing the authenticity token GUI at S320, the user device 120 may display the authenticity token GUI including a machine-readable optical label via a display (not shown), and the redemption provider device 170 may scan the machine-readable optical label. The machine-readable optical label provides data identifying the authenticity token of the webpage UAT (thereby identifying the webpage UAT with respect to the database 145). Such identifying information may include, but is not limited to, a uniform resource locator (URL) of the authenticity token.

As another non-limiting example for providing the authenticity token GUI at S320, the user device 120 and the redemption provider device 170 may communicate with each other via near field communication (NFC) in order to transmit the content to be displayed as the GUI display area or the URL of the authenticity token webpage from the user device 120 to the redemption provider device 170, thereby enabling the redemption provider device 170 to identify the webpage UAT in the database in order to verify a redemption status of that webpage UAT in the database 145. Further, the data of the authenticity token webpage data may be tokenized, e.g., by substituting that data with a token including a series of randomly generated numbers, and the tokenized authenticity token webpage data may be transmitted via NFC. The authenticity token webpage data may be tokenized, for example, by a system of an owner or operator of the database 145.

At 330, when the redemption provider device 170 obtains the data of the authenticity token as described above with respect to 320, the redemption provider device 170 is configured to access the database 145 in order to retrieve data indicating a redemption status of a redemption associated with the webpage UAT. In some implementations, the redemption provider device 170 may further retrieve data about the redemption such as, but not limited to, which premiums are to be provided upon redemption. The redemption provider device 170 may further verify the redemption eligibility of the premium using the retrieved redemption status data and may alter the database 145 or send a request to modify the database 145 (e.g., to a server of an operator of the database 145) in order to update the redemption status (i.e., to indicate that the premium has been redeemed).

At 340, once the redemption provider device 170 has verified that the premium is still redeemable, the redemption is provided to the user of the user device 120. Providing the redemption may include, but is not limited to, displaying an instruction to provide the premium on a terminal (not shown) of the redemption provider device 170, sending a digital receipt for the premium redemption to the user device 120, sending redeemed content (e.g., digital media files, software applications, etc.) to the user device 120, combinations thereof, and the like.

FIG. 4 is a flowchart 400 illustrating a method for providing a redemption via a webpage UAT according to an embodiment. In an embodiment, the method is performed by the redemption provider device 170, FIG. 1.

At S410, authenticity data of a webpage UAT is obtained via a user device (e.g., the user device 120, FIG. 1). The authenticity data is retrieved by the user device from a database (e.g., the database 145, FIG. 1) and includes data which can be used to verify the authenticity of a corresponding webpage UAT. More specifically, such authenticity data is accessed by the user device navigating to the webpage of the webpage UAT and interacting with the webpage, thereby sending a request for the contents of the webpage to the system on which the webpage content is stored. The authenticity data further identifies the webpage UAT with respect to information stored in a database (e.g., an identifier of a webpage NFT node stored in the database 145, FIG. 1).

As noted above, the webpage is encoded into portions of code at least including code for projecting media content representing a digital or physical asset as well as code for providing authenticity data. The code for providing the authenticity data may include, but is not limited to, code for displaying a machine-readable optical label including the authenticity data such that, when the machine-readable optical label is scanned (e.g., by the redemption provider device 170, FIG. 1), the authenticity data is read by the scanning device. Alternatively, the code for providing the authenticity data may include code for transmitting the authenticity data via near field communication (NFC).

In a further embodiment, the machine-readable optical label may be generated, for example when the authenticity data is requested. When generated this way, the machine-readable optical label may be embedded with a timestamp indicating a date, a time, or both, at which the label was generated. When the webpage identified in the label is visited, the device displaying the webpage may further display the date and/or time of the timestamp. This may allow, for example, a person viewing the authenticity webpage to confirm that the authenticity has been recently verified (e.g., within the past hour, day, week, etc.). In this regard, it is noted that authenticity webpages may be considered stale or otherwise expired after a certain period of time passes since the webpage was generated such that a redemption cannot be confirmed as eligible based on such a stale authenticity webpage.

At S420, a redemption status is verified using data stored in a webpage UAT database accessed based on the obtained authenticity data. As noted above, the authenticity data identifies a webpage UAT. The database is accessed in order to identify a node representing the webpage UAT (e.g., the UAT node 201, FIGS. 2A-B), which in turn may be connected to a premium node (e.g., the premium node 214, FIGS. 2A-B). In an embodiment, S420 includes accessing the premium node connected to such a UAT node of the webpage UAT in order to retrieve data about the premium including, but not limited to, a redemption status. The redemption status is verified based on the retrieved data. For example, verifying the redemption status may include verifying that the premium has not been redeemed or otherwise verifying that the premium has not been redeemed the maximum number of allowed times.

At optional S430, multi-factor authentication may be performed with respect to the user device from which the authenticity token data was obtained. As a non-limiting example, the multi-factor authentication may be performed by sending, either directly (e.g., directly from one device to another) or indirectly (e.g., via a third party system), code or a challenge to a designated device or account of the user attempting to redeem the premium. As noted herein, the webpage UAT is uniquely associated with the user. Accordingly, accessing the webpage UAT may serve as a first factor of authentication. Requiring additional factors of authentication may improve security of the redemption process in the event that, for example, a secret URL of the webpage UAT is stolen and attempted to be used for redeeming the premium.

At S440, eligibility of the redemption is confirmed based on the redemption status and optionally based on the multi-factor authentication. In an embodiment, the redemption is only confirmed as eligible when the premium has not been redeemed or otherwise when the premium has not been redeemed the maximum number of allowed times. In a further embodiment, the redemption is only confirmed as eligible if the multi-factor authentication is successful in addition to verifying the redemption status.

At S450, when the redemption is confirmed to be eligible, the premium is redeemed for the user of the user device. Redeeming the premium may include, but is not limited to, displaying a notification on a terminal operated by an agent of the redemption provider to provide premium items to the redeeming user (e.g., a user of the user device which provided authenticity data in order to attempt to redeem the premium), sending media content to the user device of the redeeming user, sending a receipt for the redeemed premium to the user device of the redeeming user, combinations thereof, and the like.

In an embodiment, the redeemed premium may be an opportunity to participate in a survey. In such embodiments, when the redemption has been confirmed as eligible, the user of the user device is permitted to cast a vote. To this end, one or more voting questions may be presented to the user of the redeeming user device, for example, via a kiosk operated by the redemption provider or via the user device itself (e.g., by displaying the voting questions on a display of the kiosk or of the user device). The user may cast their vote by providing responses to the voting questions (e.g., by a user interface of the kiosk or user device). In some embodiments, the vote cast by the user may be recorded as a voting node (e.g., the voting node 215, FIG. 2B) connected to the premium node (e.g., the premium node 214) representing the redeemed premium.

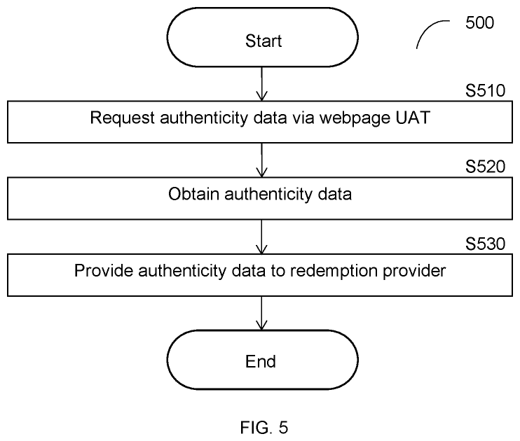

FIG. 5 is a flowchart 500 illustrating a method for demonstrating authenticity via an authenticity graphical user interface display area in order to enact a redemption. In an embodiment, the method is performed by the user device 120, FIG. 1.

At S510, a request for authenticity data is sent via a webpage UAT. In an embodiment, S510 includes accessing the webpage UAT, for example by navigating to a URL of the webpage UAT via a web browser. In a further embodiment, S510 includes receiving user inputs of a user interacting with the webpage UAT (e.g., via a user interface) and sending the request for authenticity data in response to the user inputs. As a non-limiting example, a user may click on an interactable icon labeled “Authenticity Token” tap the interactable icon via a touch screen and, in response to that user interaction, a request is sent for the relevant authenticity data.

In some embodiments, the request may require one or more forms of authentication, for example, via a wallet device or application associated with the UAT node. To this end, it may be checked whether the user interactions originated from a webpage accessed via such a wallet device or application.

At S520, the requested authenticity data is obtained. In an embodiment, the authenticity data may be stored in the database in which the code of the webpage UAT is stored. To this end, S520 includes receiving the authenticity data from the database. More specifically, the received authenticity data may be stored in an authenticity token node connected to the UAT node representing the webpage UAT stored in the database (e.g., the authenticity token node 213 connected to the UAT node 201, FIGS. 2A-C).

At S530, at least a portion of the authenticity data is provided to a device of a redemption provider (e.g., the redemption provider device 170, FIG. 1). The authenticity data may be provided, for example, by displaying a machine-readable optical label containing the authenticity data, transmitting the authenticity data via near field communication, and the like.

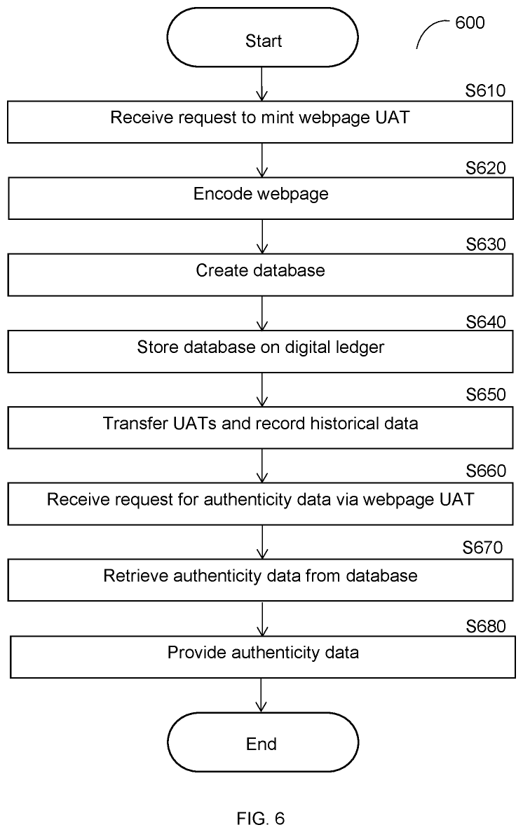

FIG. 6 is a flowchart 600 illustrating a method for delivering authenticity graphical user interface display areas via webpage unique asset tokens (UATs) according to an embodiment. In an embodiment, the method is performed by the UAT provider system 130.

At S610, a request to mint a webpage as a UAT is received. The request may include, but is not limited to, information needed to access the website (e.g., a uniform resource locator, authentication credentials, etc.). The request may further include various restrictions to be applied to the UATs representing the webpage. Such restrictions may include, but are not limited to, terms of service, usage policies, access codes, combinations thereof, and the like. The minting process at least includes encoding all or a portion of the webpage as well as adding tokens for the webpage to a database as described further below.

The webpage is associated with one or more physical or digital assets and includes media content representing the associated assets. As a non-limiting example where the asset is a digital music track, the webpage associated with the asset may include music content of the digital music track, and may further include supplementary content such as text including lyrics to a song, album cover art, text including band biography information, and the like. As a non-limiting example where the asset is a physical comic book, the webpage associated with the asset may include scanned images showing pages and/or the cover of the comic book, and may further include supplementary content such as an author's or artist's signature.

In accordance with various disclosed embodiments, the webpage UAT is associated with a redeemable premium. To this end, the request to mint the webpage UAT may include, but is not limited to, information defining the conditions for the premium (e.g., the number of times the premium is allowed to be redeemed), information about the premium itself (e.g., a textual description of the premium item, a location of a computer resource acting as the premium such as a network location, media content of the premium, etc.), both, and the like.

At S620, the webpage is encoded into one or more portions of code. The portions of code include instructions that, when executed by a system (for example, at the user device 120, FIG. 1), causes the system to project media content (e.g., by rendering images or other visual content, projecting sound for audio content, combinations thereof, and the like). Accordingly, such code can be stored in a database (specifically, in nodes of the database) such that the appropriate code can be provided (e.g., to a user device) when the owner of the UAT representing the respective portion(s) of code requests to access the content, and execution of the code on a device of that owner allows for displaying or otherwise projecting the media content to that owner.

In an embodiment, S620 includes creating or identifying the webpage for the UAT. The webpage may be an existing webpage, or may be created based on media content provided by a web content provider. The webpage may therefore be identified based on identification details in the request received at S610 or created based on media content provided via the request.

In accordance with various disclosed embodiments, the portions of code for the encoded webpage include code for causing display of authenticity information in a display area of a device which navigated to the webpage (e.g., a device used by the owner of the UAT). To this end, the portions of code may include code for rendering a display area (e.g., a GUI display area such as a window) or code for otherwise displaying interactable elements which can prompt the device to navigate to a webpage having the display area (e.g., code for displaying an icon which, when interacted with, activates a link to a location of an authentication webpage). The portions of code may further include code for retrieving the relevant authenticity data for the UAT from a database created as described below. More specifically, such code may include instructions for accessing and parsing nodes representing or associated with the UAT which may contain such authenticity data for the UAT such as, but not limited to, UAT nodes, authenticity token nodes, series nodes, transfer nodes, terms of service nodes, usage policy nodes, combinations thereof, and the like.

In some implementations, the portions of code for the encoded webpage may include code for displaying a machine-readable optical label (e.g., a barcode such as a quick response [QR] code) or otherwise for projecting computer-readable media content. The computer-readable media content may contain information for projecting the display area or otherwise for navigating to a webpage adapted to project content demonstrating the authenticity information. The computer-readable media content may be displayed in a portion of the webpage displayed on a device, and may be displayed automatically when the user is viewing the webpage or may be displayed when the user interacts with the interactable element (i.e., signaling that the user wishes for the computer-readable media content to be displayed).

This projection of computer-readable media content may allow other users to view the authenticity data on their own devices. As a non-limiting example, a user who owns a UAT may click on an authenticity token icon, thereby causing display of a display area showing a QR code on a first smartphone. Another person may scan the QR code using a second smartphone, thereby allowing them to view the authenticity display area on the second smartphone.

At S630, a database is created based on the encoded webpage. Creating the database may include creating a new database or adding to an existing database.

The created database includes nodes, and the portions of code of the encoded webpage are distributed among at least some of the nodes of the database. In an embodiment, the database at least includes webpage nodes and UAT nodes. Each webpage node is associated with a respective webpage and indicates at least a portion of the respective webpage that is represented by the node. Each UAT node represents a UAT indicating ownership of a webpage or portion thereof. Each UAT node is at least connected to one or more webpage nodes. In a further embodiment, the portions of code are distributed among the webpage nodes.

In accordance with various disclosed embodiments, the database further includes premium nodes connected to respective UAT nodes. Each premium node represents a respective redeemable premium associated with a given UAT. Each premium node at least stores a redemption status of the premium such as, but not limited to, whether the premium has been redeemed, a number of times the premium has been redeemed, and the like.

The UAT nodes represent tokens which indicate ownership of one or more non-interchangeable assets with respect to a webpage. Such assets may include, but are not limited to, books, albums, tracks, videos, movies, tickets (e.g., concert tickets), graphic novels, trading cards, representations thereof, combinations thereof, portions thereof, and the like. The unique assets represented by UATs in the database include media content of webpages which represents underlying digital or physical assets. The UAT nodes may further represent ownership of the underlying digital or physical assets.

The UATs include tokens representing non-interchangeable items such as, but not limited to, non-fungible tokens (NFTs), provenance and documentation tokens (PDTs), and the like. A UAT is a non-interchangeable token representing a digital item (i.e., a data item). A PDT is a non-interchangeable token representing a physical item. These tokens are non-interchangeable at least in that any given NFT or PDT is not necessarily equivalent to any other token of the same type, in other words, at least some UATs represent different underlying digital items as compared to at least some other UATs and likewise for PDTs. It should be noted that some UATs may be equivalent to each other without departing from the scope of the disclosed embodiments. As a non-limiting example, some UATs may be UATs representing music tracks where some of those UATs may represent the same music track and others may represent different music tracks, or each UAT may represent a distinct music track.

In some embodiments, multiple UAT nodes may be connected to a given webpage node, thereby establishing fractional ownership of the webpage, the underlying item represented by the webpage, or both. Such fractional ownership may include equal shares of ownership or may be defined as percentage ownerships that may differ among the multiple owners. In some implementations, when a UAT having multiple owners with fractional ownership (i.e., a UAT represented by a UAT node among multiple UAT nodes connected to a given webpage node) is transferred in exchange for a different item or currency, ownership of the item or currency may be distributed among the fractional owners according to their respective shares or percentage ownership.

The nodes of the database may further include other types of nodes such as, but not limited to, wallet nodes, website nodes, location identifier nodes (e.g., uniform resource locator or URL nodes), section nodes, transfer nodes, terms of service nodes, usage policy nodes, content nodes, combinations thereof, and the like. Various examples of different types of nodes are described with respect to FIGS. 2A-B as discussed above.

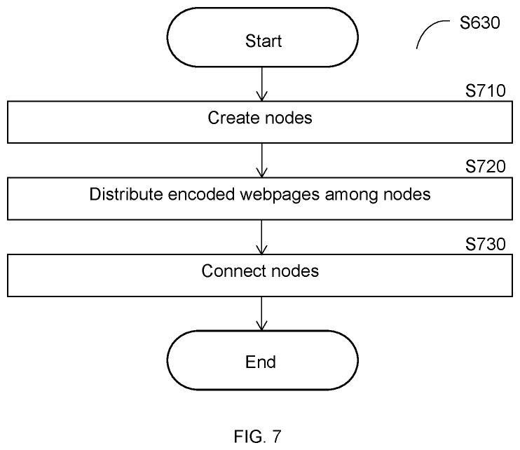

In an embodiment, the database may be created as discussed with respect to FIG. 7. FIG. 7 is a flowchart S630 illustrating a method for creating a UAT database according to an embodiment.

At S710, nodes of the database are created. In an embodiment, the nodes in the database at least include webpage nodes representing encoded webpages or portions thereof as well as UAT nodes representing UATs indicating ownership of respective webpages or portions thereof. In a further embodiment, the nodes of the database include nodes associated with entities who own the UATs such as wallet nodes representing wallets owned by such entities or owning entity nodes representing the entities themselves. In yet a further embodiment, the nodes of the database may further include any of the other nodes described above with respect to FIGS. 2A-C. It should be noted that the database may include other nodes without departing from the scope of the disclosure.

In accordance with various disclosed embodiments, the nodes of the database may further store historical data of transactions in which UATs are transferred. To this end, in a further embodiment, creating the nodes includes storing initial transaction data in one or more of the nodes. As a non-limiting example, transaction data representing the initial creation of each UAT may be stored in the respective UAT node for each UAT when the UAT nodes are created. Alternatively, the initial transaction data may be null data representing that no transactions involving the UAT have occurred yet.

The transaction data stored in the database may be used to demonstrate authenticity of any given UAT represented by one of the UAT nodes in the database. As a non-limiting example, the webpage of a given UAT may include an icon or other interactable artifact representing an authenticity token, which in turn has a corresponding certificate of authenticity webpage or otherwise prompts display of a view showing authenticity information such as a GUI display area. Such a certificate of authentication webpage or other display area may include information such as, but not limited to, transaction history for the UAT, a creator of the UAT, a source UAT platform on which the UAT was sold, serial number, associated series (e.g., a series represented by a series node such as the series node 216, FIG. 2C), usage statistics (e.g., how often the app is used), applicable usage policies, terms of a minting contract, rights contract, terms of service, or any other information that may be relevant to understanding use or ownership of the app as a UAT. This information may be at least partially derived from data stored in the database such as the transaction data.

As noted above, the transaction data stored in the database may be accessed by code of encoded webpages associated with UATs in order to retrieve information related to transaction history, origination, or otherwise related to authenticity of the UATs. The transaction data, when accessed, can be used to populate a display area showing authenticity-related information.

At S720, the portions of code of encoded webpages are distributed among the created nodes. In an embodiment, the portions of code may be distributed into webpage nodes of the respective webpages which were encoded into those portions of code. As a non-limiting example, a first webpage may be encoded into a first portion of code and a second webpage may be encoded into a second portion of code such that the first portion of code is distributed to a first webpage node representing the first webpage and the second portion of code is distributed to a second webpage node representing the second webpage.

At S730, the created nodes are connected. In an embodiment, the created nodes are connected at least such that each UAT node is connected to a respective webpage node representing the webpage provided as a UAT. In a further embodiment, the created nodes may be connected such that each UAT node is also connected to a wallet node or owning entity node associated with the entity who owns the UAT. In another embodiment, the created nodes may be connected such that each UAT node is further connected to nodes for enforcing restrictions on use or access of the respective UAT such as, but not limited to, transaction nodes, terms of service nodes, usage policy nodes, access code nodes, combinations thereof, and the like.

Returning to FIG. 6, at optional S640, the database is stored on a digital ledger. In an embodiment, S640 may include uploading the database to a decentralized digital ledger such as a blockchain. As noted above, storing the database on a blockchain allows for ensuring the accuracy of the data in the database by providing an immutable record against which the database can be compared when making transfers, and storing the database on a decentralized ledger in addition to a centralized ledger allows for portability, i.e., the database may be transferred to a new digital ledger relatively easily. As a non-limiting example, the database may be stored as a side chain on a blockchain.

At optional S650, one or more of the UAT nodes are transferred to a new owner. In an embodiment, S650 may occur when a request to transfer the UAT nodes is received from a current owner of the UAT nodes. The request may indicate to transfer the UAT nodes immediately or upon meeting one or more conditions. The request may be received from a wallet of the current owner. In an embodiment, transferring the UATs may include reconnecting the respective UAT nodes corresponding to those UATs.

In accordance with various disclosed embodiments, S650 further includes recording historical data indicating the most recent transaction or transactions as part of the transaction data for the UAT. Such historical data may be recorded, for example, in a UAT node of the UAT in the database.

At S660, a request for authenticity data is received. In an embodiment, the request is received via a webpage UAT and, more specifically, based on user interactions with the webpage UAT (e.g., via interactions through a GUI displayed on a device that navigated to the webpage UAT). In another embodiment, the authenticity information may be displayed as part of the webpage UAT by default such that the request for authenticity information is a request for the webpage UAT itself.

When the request is received via user interactions with a webpage corresponding to a particular UAT, the request may be received in response to a user interacting with an interactable element displayed in the webpage. As a non-limiting example, the request may be received when a user clicks on an “authenticity token” icon representing the desired authenticity information.

To this end, the user may first request the webpage corresponding to the UAT by navigating to a location of the webpage, thereby causing their user device to request content of the webpage. When the portions of code of the webpage are received and executed on the user device, an interactable element representing an authenticity token (e.g., a token of the authenticity information) is displayed. The user may then interact with the interactable element, thereby requesting the authenticity information.

When the request is a request for the webpage UAT itself, the request may be received by a user navigating, via their user device, to a location (e.g., a uniform resource locator) of a webpage corresponding to the UAT they own. When the user navigates to such a location (e.g., via a browser software application installed on the user device), the user device requests the web content of the webpage from a host server, thereby requesting content showing the authenticity information. When the host server provides such web content to the user device and the code included therein is executed on the user device, the user device becomes configured to display the web content including the authenticity information therein.

At S670, the authenticity data is retrieved from the database. In an embodiment, S670 includes retrieving the authenticity data from certain nodes in the database such as, but not limited to, UAT nodes, authenticity token nodes, series nodes, transfer nodes, terms of service nodes, usage policy nodes, combinations thereof, and the like. To this end, it is noted that the request for the authenticity data may specify the UAT node for which authenticity data is requested or may otherwise include identifying details for the UAT for which the authenticity data should be retrieved.

At S680, the authenticity data is provided. The authenticity data may be provided directly for the purpose of populating a display area with the authenticity data, or may be provided in the form of an authenticity webpage populated with the authenticity data.

In some implementations, content of the webpage and, in particular, the code for displaying the authenticity display area, may be stored on the user device for subsequent use. As a non-limiting example, the code may be stored in a cache. Storing the code in a cache or other local storage of the user device allows for accessing the authenticity display area even when the user device is not connected to the Internet. In other implementations, an Internet connection may be required to access the authenticity display area.

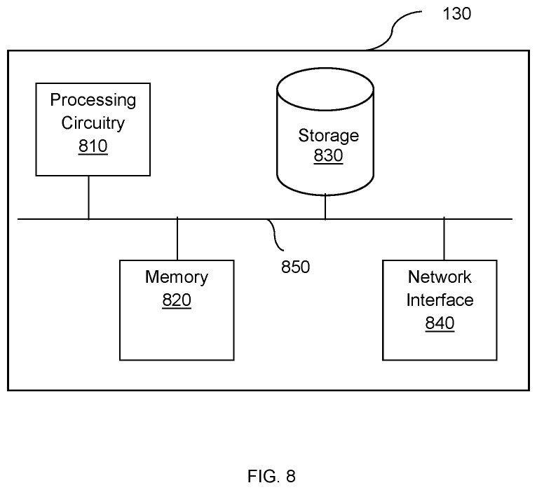

FIG. 8 is an example schematic diagram of a unique asset token (UAT) provider system 130 according to an embodiment. The UAT provider system 130 includes a processing circuitry 810 coupled to a memory 820, a storage 830, and a network interface 840. In an embodiment, the components of the UAT provider system 130 may be communicatively connected via a bus 850.

The processing circuitry 810 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 820 may be volatile (e.g., random access memory, etc.), non-volatile (e.g., read only memory, flash memory, etc.), or a combination thereof.

In one configuration, software for implementing one or more embodiments disclosed herein may be stored in the storage 830. In another configuration, the memory 820 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 810, cause the processing circuitry 810 to perform the various processes described herein.

The storage 830 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 840 allows the UAT provider system 130 to communicate with, for example, the user device 120, the data storage 140, the web content sources 150, the blockchain network 160, combinations thereof, and the like.

It should be understood that the embodiments described herein are not limited to the specific architecture illustrated in FIG. 8, and other architectures may be equally used without departing from the scope of the disclosed embodiments.

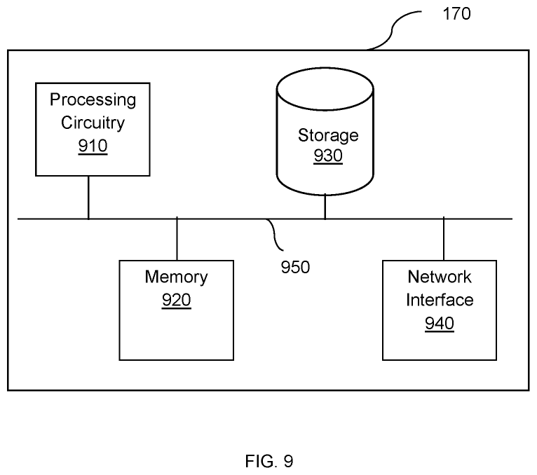

FIG. 9 is an example schematic diagram of a redemption provider device 170 according to an embodiment. The redemption provider device 170 includes a processing circuitry 910 coupled to a memory 920, a storage 930, and a network interface 940. In an embodiment, the components of the redemption provider device 170 may be communicatively connected via a bus 950.

The processing circuitry 910 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 920 may be volatile (e.g., random access memory, etc.), non-volatile (e.g., read only memory, flash memory, etc.), or a combination thereof.

In one configuration, software for implementing one or more embodiments disclosed herein may be stored in the storage 930. In another configuration, the memory 920 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 910, cause the processing circuitry 910 to perform the various processes described herein.

The storage 930 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 940 allows the redemption provider device 170 to communicate with, for example, the user device 120, the data storage 140, both, and the like.

It should be understood that the embodiments described herein are not limited to the specific architecture illustrated in FIG. 9, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for providing redemptions via webpage unique asset tokens, comprising:
obtaining authenticity data from a user device when the user device has navigated to a webpage uniquely associated with a unique asset token (UAT), wherein the webpage is encoded into a plurality of portions of code including code for providing the authenticity data;
accessing a database with respect to the authenticity data in order to retrieve at least a redemption status of a premium to be redeemed, the database storing a plurality of nodes including a plurality of UAT nodes and a plurality of premium nodes, wherein a first UAT node of the plurality of UAT nodes corresponds to the UAT and is connected to a first premium node of the plurality of premium nodes, the first premium node representing the premium to be redeemed, wherein the plurality of portions of the code of the webpage is stored among the plurality of nodes;
verifying eligibility of the premium for redemption based on the redemption status of the first premium node; and
redeeming the premium when the eligibility of the premium has been verified.

2. The method of claim 1, wherein obtaining the authenticity data further comprises:
scanning a machine-readable optical label visible via a graphical user interface (GUI) display area displayed via the user device, wherein the machine-readable optical label includes the authenticity data.

3. The method of claim 1, wherein obtaining the authenticity data further comprises:
receiving the authenticity data from the user device via a transmission using near field communication.

4. The method of claim 1, wherein redeeming the premium further comprises:
displaying, via a terminal, a notification indicating that the premium has been redeemed.

5. The method of claim 1, wherein the premium is a survey, wherein the redeeming the premium further comprises providing at least one voting question to a user of the user device and storing at least one response to the at least one voting question in the database.

6. The method of claim 1, wherein the plurality of nodes further includes a plurality of webpage nodes, the plurality of webpage nodes including a first webpage node representing the webpage uniquely associated with the UAT, wherein the first webpage node is connected to the first UAT node in the database.

7. The method of claim 1, further comprising:
sending, to an account associated with the user device, a request for a multi-factor authentication, wherein the premium is only redeemed when the requested multi-factor authentication is successful.

8. The method of claim 1, wherein the database is stored on a plurality of nodes as a digital ledger of a blockchain, wherein accessing the database further comprises retrieving data from the blockchain.

9. The method of claim 8, further comprising:
altering the redemption status of the premium when the premium is redeemed; and
recording a transaction indicating the altered redemption status on the blockchain.

10. A non-transitory computer readable medium having stored thereon instructions for causing a processing circuitry to execute a process, the process comprising:
obtaining authenticity data from a user device when the user device has navigated to a webpage uniquely associated with a unique asset token (UAT), wherein the webpage is encoded into a plurality of portions of code including code for providing the authenticity data;
accessing a database with respect to the authenticity data in order to retrieve at least a redemption status of a premium to be redeemed, the database storing a plurality of nodes including a plurality of UAT nodes and a plurality of premium nodes, wherein a first UAT node of the plurality of UAT nodes corresponds to the UAT and is connected to a first premium node of the plurality of premium nodes, the first premium node representing the premium to be redeemed, wherein the plurality of portions of the code of the webpage is stored among the plurality of nodes;
verifying eligibility of the premium for redemption based on the redemption status of the first premium node; and
redeeming the premium when the eligibility of the premium has been verified.

11. A system for providing redemptions via webpage unique asset tokens, comprising:
a processing circuitry; and
a memory, the memory containing instructions that, when executed by the processing circuitry, configure the system to:
obtain authenticity data from a user device when the user device has navigated to a webpage uniquely associated with a unique asset token (UAT), wherein the webpage is encoded into a plurality of portions of code including code for providing the authenticity data;
access a database with respect to the authenticity data in order to retrieve at least a redemption status of a premium to be redeemed, the database storing a plurality of nodes including a plurality of UAT nodes and a plurality of premium nodes, wherein a first UAT node of the plurality of UAT nodes corresponds to the UAT and is connected to a first premium node of the plurality of premium nodes, the first premium node representing the premium to be redeemed, wherein the plurality of portions of the code of the webpage is stored among the plurality of nodes;
verify eligibility of the premium for redemption based on the redemption status of the first premium node; and
redeem the premium when the eligibility of the premium has been verified.

12. The system of claim 11, wherein the system is further configured to:
scan a machine-readable optical label visible via a graphical user interface (GUI) display area displayed via the user device, wherein the machine-readable optical label includes the authenticity data.

13. The system of claim 11, wherein the system is further configured to:
receive the authenticity data from the user device via a transmission using near field communication.

14. The system of claim 11, wherein the system is further configured to:
display, via a terminal, a notification indicating that the premium has been redeemed.

15. The system of claim 11, wherein the premium is a survey, wherein the redeeming the premium further comprises providing at least one voting question to a user of the user device and storing at least one response to the at least one voting question in the database.

16. The system of claim 11, wherein the plurality of nodes further includes a plurality of webpage nodes, the plurality of webpage nodes including a first webpage node representing the webpage uniquely associated with the UAT, wherein the first webpage node is connected to the first UAT node in the database.

17. The system of claim 11, wherein the system is further configured to:
send, to an account associated with the user device, a request for a multi-factor authentication, wherein the premium is only redeemed when the requested multi-factor authentication is successful.

18. The system of claim 11, wherein the database is stored on a plurality of nodes as a digital ledger of a blockchain, wherein accessing the database further comprises retrieving data from the blockchain.

19. The system of claim 18, wherein the system is further configured to:
alter the redemption status of the premium when the premium is redeemed; and
record a transaction indicating the altered redemption status on the blockchain.
